(19) United States
(12) Patent Application Publication
(10) Pub. No.: US 2025/0159745 A1
(43) Pub. Date: May 15, 2025

(54) ELECTRONIC DEVICE FOR DATA COMMUNICATION WITH PERIPHERAL DEVICE AND OPERATION METHOD THEREFOR

(71) Applicant: SAMSUNG ELECTRONICS CO., LTD., Suwon-si (KR)

(72) Inventor: Dongik LEE, Suwon-si (KR)

(73) Assignee: SAMSUNG ELECTRONICS CO., LTD., Suwon-si (KR)

(21) Appl. No.: 19/007,059

(22) Filed: Dec. 31, 2024

Related U.S. Application Data
(63) Continuation of application No. PCT/KR2023/008476, filed on Jun. 19, 2023.

(30) Foreign Application Priority Data
Aug. 19, 2022 (KR) 10-2022-0104207

(51) Int. Cl. H04W 76/15; G06F 8/65; H04W 4/80; H04W 8/24; H04W 84/12

(52) U.S. Cl. CPC H04W 76/15; G06F 8/65; H04W 4/80; H04W 8/245; H04W 84/12

(57) ABSTRACT

An electronic device for data communication with a peripheral device and an operation method therefor are provided. The electronic device establishes a first wireless communication link with an access point (AP) connected to a network, obtains, from an external electronic device located adjacent to the electronic device, identification information of the external electronic device, establishes a second wireless communication link with the external electronic device based on the identification information of the external electronic device, obtains software update information of the external electronic device from the network via the first wireless communication link, stores the software update information of the external electronic device in the memory, determines to update software of the external electronic device, and provides the software update information of the external electronic device to the external electronic device via the second wireless communication link.

### CROSS REFERENCE TO RELATED APPLICATIONS

This application is a bypass continuation application of International Application No. PCT/KR2023/008476, filed on Jun. 19, 2023, which is based on and claims priority to Korean Patent Application No. 10-2022-0104207, filed on Aug. 19, 2022, in the Korean Patent Office, the disclosures of which are incorporated by reference herein in their entireties.

### BACKGROUND

### 1. Field

The disclosure relates to an electronic device for data communication with a peripheral device and an operation method therefor.

### 2. Description of Related Art

Along with the commercialization of an intelligent communication infrastructure between objects with a wireless communication function, that is, an internet of things (IoT) technology, wireless communication modules are being installed not only onto mobile devices such as, e.g., a smartphone, a laptop or notebook computer, or the like that is portable to a user, but also on electronic devices that are difficult for a user to carry, such as e.g., a television, an air conditioner, an air cleaner, a vacuum cleaner, a refrigerator, an cooking oven, or the like. These IoT devices may transmit and receive data mutually using a certain wireless communication technology such as, ZigBee, Z-Wave, Bluetooth (BT)/Bluetooth low energy (BLE), WiFi, WiFi Direct, or a cellular network (e.g., LTE or 5G). Various IoT-based application technologies have been developed, such as, a technology for detecting a malfunction of devices connected using the IoT technology, a technology for collecting data, and a technology for encrypting an IoT connection using a block chain.

The Wi-Fi Direct is a technology that provides a peer-to-peer (P2P) protocol connection scheme for direct connection of communication between electronic devices supporting the Wi-Fi function without network infrastructure equipment (e.g., an access point (AP), a hotspot, or a router). The Wi-Fi Direct may be installed not only in smartphones but also in televisions (TVs), notebook computers, cameras, printers, video gaming device, sound bars, set-top boxes, and other IoT devices, to support direct communication between electronic devices.

As TV display panel technology is advanced, data unique to TV devices are increasing, and in case of replacing an integrated circuit (IC) or a printed circuit board (PCB) mounted therein due to a defect in a TV device, it may be necessary to efficiently back up existing data stored therein.

### SUMMARY

Provided are an electronic device for utilizing an automatic connection between an electronic device (e.g., a TV) and an external electronic device (or a peripheral device) to efficiently manage the data through a storage space between those electronic devices mutually connected, and an operating method thereof.

According to an aspect of the disclosure, there is provided an electronic device, including: communication circuitry; memory storing instructions; and at least one processor operatively connected to the communication circuitry and the memory, wherein the instructions, when executed by the at least one processor, cause the electronic device to: establish a first wireless communication link with an access point (AP) connected to a network; obtain, from an external electronic device located adjacent to the electronic device, identification information of the external electronic device; establish a second wireless communication link with the external electronic device based on the identification information of the external electronic device; obtain software update information of the external electronic device from the network via the first wireless communication link; store the software update information of the external electronic device in the memory; determine to update software of the external electronic device; and provide the software update information of the external electronic device to the external electronic device via the second wireless communication link.

The instructions, when executed by the at least one processor, may cause the electronic device to: identify that image quality data of the electronic device is not backed up; and provide the image quality data to the external electronic device via the second wireless communication link.

The first wireless communication link may be established based on WiFi technology, and the second wireless communication link may be established based on WiFi Direct technology.

The identification information of the external electronic device may include a Wi-Fi media access control (MAC) address of the external electronic device and software version information of the external electronic device.

The instructions, when executed by the at least one processor, may cause the electronic device to: based on the software version information of the external electronic device not matching the software update information of the external electronic device, determine to update the software of the external electronic device; and based on the software version information of the external electronic device matching the software update information of the external electronic device, determine to not update the software of the external electronic device.

The identification information of the external electronic device may be obtained through a wired communication link based on a high-definition multimedia interface (HDMI) or a wired communication link through an optical cable.

The instructions, when executed by the at least one processor, may cause the electronic device to: establish a third communication link with the external electronic device; and obtain the identification information of the external electronic device from the external electronic device based on the third communication link, wherein the third communication link may be established based on Bluetooth communication technology.

The identification information of the external electronic device may be obtained through the AP, and wherein the external electronic device may be connected to the AP.

The instructions, when executed by the at least one processor, may cause the electronic device to: compress the software update information, and provide the compressed software update information to the external electronic device via the second wireless communication link.

The instructions, when executed by the at least one processor, may cause the electronic device to, based on identifying that a device unique identifier (DUID) of the electronic device is changed, obtain the image quality data from the external electronic device.

According to an aspect of the disclosure, there is provided an external electronic device, including: communication circuitry; memory storing instructions; and at least one processor operatively connected to the communication circuitry and the memory, wherein the instructions, when executed by the at least one processor, cause the external electronic device to: provide identification information of the external electronic device to an electronic device located adjacent to the external electronic device; establish a wireless communication link with the electronic device; obtain software update information from the electronic device via the wireless communication link; and update software of the external electronic device, based on the software update information.

The instructions, when executed by the at least one processor, may cause the external electronic device to obtain image quality data of the electronic device from the electronic device via the wireless communication link, and store the image quality data of the electronic device in the memory.

The identification information of the external electronic device may include information on a Wi-Fi media access control (MAC) address of the external electronic device and software version information of the external electronic device.

The wireless communication link may be established based on WiFi Direct technology.

The identification information of the external electronic device may be provided through a wired communication link based on a high-definition multimedia interface (HDMI) or a wired communication link through an optical cable.

According to an aspect of the disclosure, a method of an electronic device, may include: establishing a first wireless communication link with an access point (AP) connected to a network; obtaining, from an external electronic device located adjacent to the electronic device, identification information of the external electronic device; establishing a second wireless communication link with the external electronic device based on the identification information of the external electronic device; obtaining software update information of the external electronic device from the network via the first wireless communication link; storing the software update information of the external electronic device in the memory; determining to update software of the external electronic device; and providing the software update information of the external electronic device to the external electronic device via the second wireless communication link.

The method of an electronic device, may include: identifying that image quality data of the electronic device is not backed up; and providing the image quality data to the external electronic device via the second wireless communication link.

The method of an electronic device, may include: based on identifying that a device unique identifier (DUID) of the electronic device is changed, obtaining the image quality data from the external electronic device.

The identification information of the external electronic device may include a Wi-Fi media access control (MAC) address of the external electronic device and software version information of the external electronic device.

The method of an electronic device, may include: based on the software version information of the external electronic device not matching the software update information of the external electronic device, determining to update the software of the external electronic device; and based on the software version information of the external electronic device matching the software update information of the external electronic device, determining to not update the software of the external electronic device.

Effects that can be obtained from example embodiments of the disclosure are not limited to those mentioned above, and other effects not mentioned herein may be clearly derived and understood by those having ordinary knowledge in the technical filed to which the example embodiments of the disclosure belong from the following description. That is, unintended effects of implementing example embodiments of the disclosure may also be derived from the example embodiments of the disclosure by those skilled in the art.

### BRIEF DESCRIPTION OF THE DRAWINGS

The above and other aspects and/or features of one or more embodiments of the present disclosure will be more apparent from the following description taken in conjunction with the accompanying drawings, in which:

FIG. 1 illustrates an example of an IoT environment according to an embodiment;

FIG. 2 illustrates a block configuration of an electronic device according to an embodiment;

FIG. 3 illustrates an operation flow of an electronic device according to an embodiment;

FIG. 4 illustrates an operation flow of an external electronic device according to an embodiment; AND

FIG. 5 illustrates a signaling flow between an electronic device and an external electronic device according to an embodiment.

With regard to the description of drawings, the same or similar reference numerals may be used to refer to the same or similar components.

### DETAILED DESCRIPTION

Hereinafter, various embodiments of the disclosure will be described in detail with reference to the accompanying drawings. However, the disclosure may be implemented in various different forms and is not limited to the embodiments described herein. In conjunction with the description of the drawings, the same or similar components may be indicated by the same or similar reference numerals. Further, in the drawings and their related descriptions, descriptions of well-known functions and configurations may be omitted for clarity and brevity.

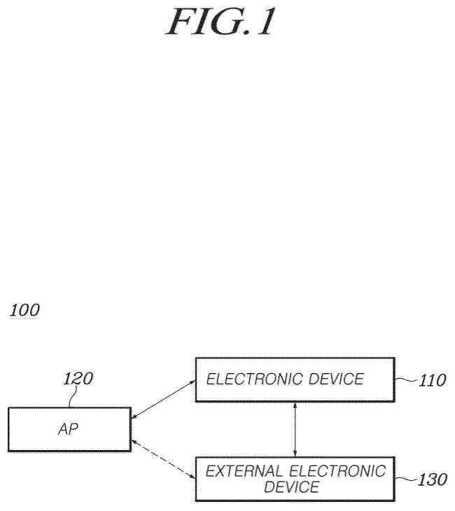

FIG. 1 illustrates an example of an IoT environment according to an embodiment.

Referring to FIG. 1, an IoT environment 100 according to an embodiment may include an electronic device 110, an access point (AP) 120, and an external electronic device 130.

The electronic device 110 according to an embodiment may include an electronic device such as e.g., a display device (e.g., a TV), a smartphone, a desktop computer, a laptop computer, a tablet personal computer (PC), a refrigerator, an air conditioner, an air cleaner, a vacuum cleaner, an oven, or the like. The electronic device 110 may be implemented including IoT technology, and may include a communication module for IoT communication.

The external electronic device 130 according to an embodiment is an electronic device located adjacent to the electronic device 110, and may include a sound bar, a set-top box, or the like. The external electronic device 130 may be implemented including IoT technology, and may include a communication module for IoT communication. In the following description, the electronic device 110 is described as a TV product and the external electronic device 130 is described as a sound bar product, but this is only an example, wherein the electronic device 110 and the external electronic device 130 may be configured to support IoT technology, and WiFi or WiFi Direct communication technology, and may be applied to any electronic device having a memory without limitation thereto.

The AP 120 according to an embodiment of the disclosure may serve as a base station in a wireless local area network (LAN) to connect a wired network and a wireless network to each other. For example, the AP 120 may serve as a bridge connecting a wireless LAN to which the electronic device 110 is connected and an IoT network server.

In order to implement IoT, the electronic device 110 according to an embodiment may transmit and receive data to and from at least one external electronic device 130 located adjacent thereto using a short-range wireless communication technology, or may transmit and receive data to and from at least one external electronic device 130 located adjacent thereto via an access point (AP) 120 connected to an IoT network server.

The electronic device 110 according to an embodiment may be connected to an IoT network server in at least one of a wired communication scheme or a wireless communication scheme. The electronic device 110 according to an embodiment may be connected to a network server via the AP 120. The external electronic device 130 according to an embodiment may be connected to a network server through the AP 120.

In an embodiment, the electronic device 110 may be connected to the IoT network server, using wireless communication technologies such as, e.g., wireless broadband (Wibro), world interoperability for microwave access (WiMax), code division multiple access (CDMA), wideband CDMA (WCDMA), 3G, 4G, long term evolution (LTE), LTE-A, 5G, new radio (NR), near field communication (NFC), Bluetooth, wireless local access network (WLAN), WiFi, or the like.

The IoT network server according to an embodiment may refer to a server, a cloud server, or a cloud server device that is interconnected with a plurality of electronic devices located at a long range to support an IoT platform. The IoT network server may refer to all the servers or devices capable of supporting the IoT platform.

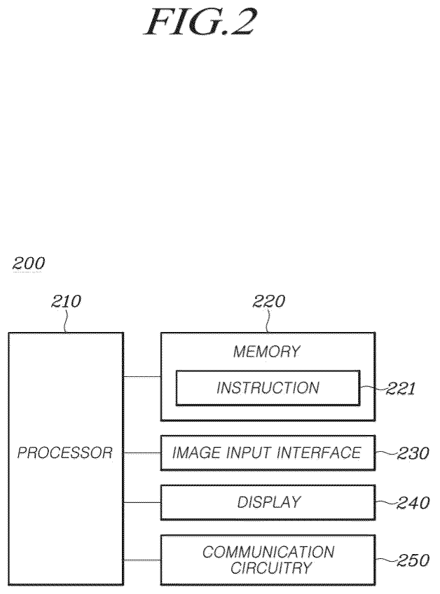

FIG. 2 illustrates a block configuration of an electronic device according to an embodiment. The electronic device of FIG. 2 may include an electronic device corresponding to the electronic device 110 of FIG. 1. In addition, the electronic device 200 may be a wearable terminal such as a wearable watch and glasses capable of performing various computing functions such as video watching, communication and the like. The electronic device 200 may be various types of terminals without being limited to those described above.

According to an embodiment, a memory 220 is a storage medium used by the electronic device 200, and may store data such as at least one instruction 221 corresponding to at least one program or configuration information. The program may include an operating system (OS) program and various application programs.

In an embodiment, the memory 220 may include at least one type of storage medium of a flash memory type memory, a hard disk type memory, a multimedia card micro type memory, a card type memory (e.g., a secure digital (SD) or extreme digital (XD) memory), a random access memory (RAM), a static random access memory (SRAM), a read only memory (ROM), an electrically erasable programmable ROM (EEPROM), a programmable ROM (PROM), a magnetic memory, a magnetic disk, or an optical disk.

According to an embodiment, an image input interface 230 may receive a viewing image and viewing image information via a tuner, an input/output interface, or communication circuitry 250. The image input interface 230 may include at least one of the tuner and the input/output interface. The tuner may tune and select only a frequency of a broadcast channel to be received by the electronic device 200 from among various radio wave components, by means of amplification, mixing, resonance, and the like of a broadcast signal received in a wired or wireless scheme. The broadcast signal may include video, audio, and additional data (e.g., an electronic program guide (EPG)). The tuner may be configured to receive a certain broadcast channel (or viewing images) from various broadcast sources such as e.g., terrestrial broadcasting, cable broadcasting, satellite broadcasting, Internet broadcasting, and the like. The tuner may be implemented integrally with the electronic device 200 or may be implemented as a separate tuner electrically connected to the electronic device 200. The input/output interface may include at least one of a High Definition Multimedia Interface (HDMI) input port, a component input jack, a PC input port, a USB input jack or the like being capable of receiving a viewing image and viewing image information from an external device of the electronic device 200 under the control of a processor 210. It will be apparent to those skilled in the art that such an input/output interface may be added, deleted, and/or changed depending upon the performance and structure of the electronic device 200.

According to an embodiment, a display 240 may perform functions for outputting information in the form of numbers, characters, images, and/or graphics. The display 240 may include at least one hardware module adapted to output information. The at least one hardware module may include, for example, at least one of a liquid crystal display (LCD), a light emitting diode (LED), a light emitting polymer display (LPD), an organic light emitting diode (OLED), an active matrix organic light emitting diode (AMOLED), or a flexible LED (FLED). The display 240 may display a screen corresponding to data received from the processor 210. The display 240 may be referred to as an ‘output unit’, a ‘display unit’, or other terms having a technical meaning equivalent thereto.

According to an embodiment, communication circuitry 250 may be configured to provide a wired/wireless communication interface that enables communication with an external device. The communication circuitry 250 may include at least one of a wired Ethernet unit, a wireless LAN communication unit, a short-range communication unit or the like. The wireless LAN communication unit may include, for example, Wi-Fi, and may be configured to support the WLAN standard IEEE802.11x of the American Institute of Electrical and Electronics Engineers (IEEE). The wireless LAN communication unit may be wirelessly connected to an access point (AP) under the control of the processor 210. The short-range communication unit may wirelessly perform short-range communication with an external device under the control of the processor 210. The short-range communication unit may include, for example, Bluetooth, Bluetooth Low Energy, Infrared Data Association (IrDA), Ultra-WideBand (UWB), Wi-Fi Direct, Near Field Communication (NFC) or the like. The external device may include a server device providing an image service or the like or a mobile terminal (e.g., a mobile phone, a tablet PC, or the like).

According to an embodiment, the processor 210 may execute at least one instruction 221 stored in the memory 220 to perform an operation or data processing related to control and/or communication of at least one other component of the electronic device 200. The processor 210 may include at least one of a central processing unit (CPU), a graphics processing unit (GPU), a micro controller unit (MCU), a sensor hub, a supplementary processor, a communication processor, an application processor, an application specific integrated circuit (ASIC), or a field programmable gate array (FPGA), or the like and may have a plurality of cores.

In an embodiment, the processor 210 may control the communication circuitry 250 to establish a first wireless communication link with an AP (e.g., the AP 120) connected to a network.

In an embodiment, the processor 210 may control the communication circuitry 250 to receive identification information of the external electronic device from an external electronic device (e.g., the external electronic device 130) located adjacent to the electronic device 200.

In an embodiment, the processor 210 may control the communication circuitry 250 to establish a second wireless communication link with the external electronic device based on the identification information of the external electronic device.

In an embodiment, the processor 210 may control the communication circuitry 250 to receive software information of the external electronic device via the first wireless communication link from the network.

In an embodiment, the processor 210 may store software update information of the external electronic device in the memory 220.

In an embodiment, the processor 210 may determine whether to update the software of the external electronic device.

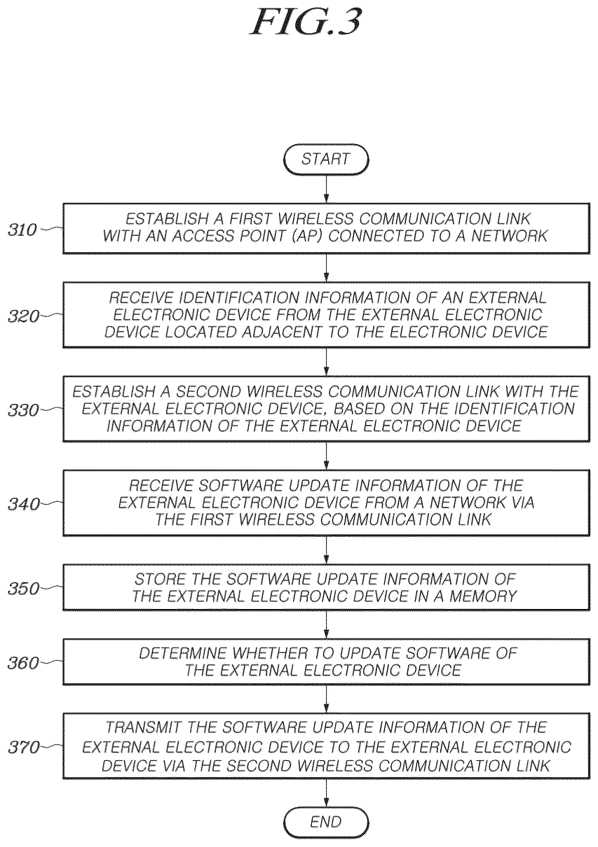

FIG. 3 illustrates an operation flow of an electronic device according to an embodiment. The electronic device of FIG. 3 may be an electronic device corresponding to the electronic device 110 of FIG. 1 and the electronic device 200 of FIG. 2. In the operation of the electronic device described with reference to FIG. 3, any redundant part described with reference to FIGS. 1 and 2 may be omitted. Some of the operations illustrated in FIG. 3 may be omitted, and other operations not illustrated in FIG. 3 may be included between any ones of the operations of FIG. 3. Throughout the following description, the electronic device may be described using a TV device as an example, and the external electronic device may be described using a sound bar device connected to the TV device as an example, but it is only of an example, and the technical contents of the operations according to FIG. 3 may be equally applied to other electronic devices.

According to an embodiment, in operation 310, the electronic device may establish a first wireless communication link with an access point (AP) (e.g., the AP 120) connected to a network. The first wireless communication link may be a wireless communication link formed between an AP and the electronic device, and may include at least a part of a link between a network (e.g., an IoT network server) and the electronic device.

In an embodiment, the first wireless communication link may be established based on signals based on WiFi technology and generated from the AP.

According to an embodiment, in operation 320, the electronic device may receive identification information of an external electronic device from the external electronic device located adjacent to the electronic device.

In an embodiment, the external electronic device may be a device located within a predetermined distance from the electronic device and may include a device capable of supporting WiFi Direct communication technology. For example, when the electronic device is a TV, the external electronic device may include a sound bar product or a set-top box disposed around the TV.

In an embodiment, the identification information of the external electronic device may include information on a Wi-Fi media access control (MAC) address of the external electronic device.

In an embodiment, the identification information of the external electronic device may include information about a current software version of the external electronic device. The information about the current software version of the external electronic device may include information about whether the software currently installed in the external electronic device is the latest version.

According to an embodiment, in operation 330, the electronic device may establish a second wireless communication link with the external electronic device, based on the identification information of the external electronic device.

In an embodiment, the second wireless communication link may be formed based on Wi-Fi Direct technology.

In an embodiment, the second wireless communication link may refer to a direct wireless communication link between the external electronic device and the electronic device, formed between the electronic device and the external electronic device.

According to an embodiment, in operation 340, the electronic device may receive software update information of the external electronic device from a network via the first wireless communication link.

In an embodiment, the electronic device may receive the software update information of the external electronic device via the AP.

In an embodiment, the electronic device may periodically receive the software update information of the external electronic device via the first wireless communication link.

In an embodiment, the software update information of the external electronic device may include data for updating the software of the external electronic device.

According to an embodiment, in operation 350, the electronic device may store the software update information of the external electronic device in a memory. The electronic device may store the software update information of the external electronic device in the memory, and then transmit the software update information to the external electronic device in case where it is determined that the software update of the external electronic device is required.

According to an embodiment, in operation 360, the electronic device may determine whether to update the software of the external electronic device.

In an embodiment, the electronic device may determine whether to update the software of the external electronic device, based on whether the software version information of the external electronic device received from the external electronic device matches the software update information of the external electronic device. For example, when the software version information of the external electronic device received from the external electronic device matches the software update information of the external electronic device, the electronic device may determine not to update the software of the external electronic device. For example, when the software version information of the external electronic device received from the external electronic device does not match the software update information of the external electronic device, the electronic device may determine to update the software of the external electronic device.

In an embodiment, the electronic device may receive the software version information of the external electronic device from the external electronic device. For example, the electronic device may establish a wireless communication link based on Bluetooth technology and may receive software information of the external electronic device via the established wireless communication link. For example, the electronic device may receive the software information of the external electronic device via an HDMI or an optical cable connecting the electronic device and the external electronic device.

In an embodiment, before establishing the second wireless communication link with the external electronic device, the electronic device may receive the software information of the external electronic device from the external electronic device via a wireless communication link (e.g., Bluetooth, HDMI, optical cable, etc.) different from the second wireless communication link.

In an embodiment, the software version information of the external electronic device may include information about a version of the software currently installed in the external electronic device. The electronic device may identify a current software state of the external electronic device based on the software version information of the external electronic device received from the external electronic device. The electronic device may determine whether the identified software state of the external electronic device is the latest state. When the software state is the latest state, the electronic device may determine that there is no need to update the software, while when the software state is not the latest state and the latest version of software update information is stored in the memory, the electronic device may then transmit the software update information of the external electronic device to the external electronic device, based on the software update information stored in the memory.

In an embodiment, the electronic device may periodically check whether the software of the external electronic device is the latest version.

According to an embodiment, in operation 360, when the electronic device determines to update the software of the external electronic device, the electronic device may proceed to operation 370.

According to an embodiment, in operation 370, the electronic device may transmit the software information of the external electronic device to the external electronic device via the second wireless communication link. The electronic device may update the software update information of the external electronic device stored in the memory at a certain time point, but the disclosure is not limited thereto, and various schemes of memory management may be used to manage the software update information of the external electronic device stored in the memory.

In an embodiment, the electronic device may update the software update information of the external electronic device stored in the memory at a predetermined time point, but the disclosure is not limited thereto, and various schemes of memory management may be used to manage the software update information of the external electronic device stored in the memory.

In an embodiment, the first wireless communication link may be established based on WiFi communication technology.

In an embodiment, the second wireless communication link may be established based on WiFi direct technology.

In an embodiment, the electronic device may transmit image quality data to the external electronic device. The image quality data may include information about a display panel of the electronic device.

In an embodiment, the electronic device may transmit the image quality data of the electronic device to the external electronic device via the second wireless communication link.

In an embodiment, the electronic device may determine whether to transmit the image quality data of the electronic device to the external electronic device. For example, when image quality data already backed up exists, the electronic device may determine not to transmit the image quality data of the electronic device to the external electronic device. For example, when the backed-up image quality data does not exist, the electronic device may determine to transmit the image quality data of the electronic device to the external electronic device. For example, when the electronic device identifies that there is a change in the image quality data, the image quality data may be transmitted to the external electronic device.

In an embodiment, the electronic device may compress the image quality data to generate compressed image quality data.

In an embodiment, the electronic device may transmit the compressed image quality data to the external electronic device via the second wireless communication link.

In an embodiment, the external electronic device may be connected to the same AP as the AP connected to the electronic device.

In an embodiment, in response to identifying that a device unique identifier (DUID) of the electronic device is changed, the electronic device may request the external electronic device to transmit the backed-up image quality data. The electronic device may receive the image quality data from the external electronic device in response to the requesting to transmit the backed-up image quality data.

Even in case where a main board or any circuit board needs to be replaced due to a problem with the TV device, the electronic device may use the method described above with reference to FIG. 3 to back up image quality data in a storage of an external electronic device located adjacent to the TV device, without having to separately back up image quality data of the TV device, thereby enabling efficient management of the data. Accordingly, even when the main board or the circuit board is to be replaced, the electronic device may be efficiently managed by receiving related data from the external electronic device located adjacent thereto, without having to download the image quality data separately from the board.

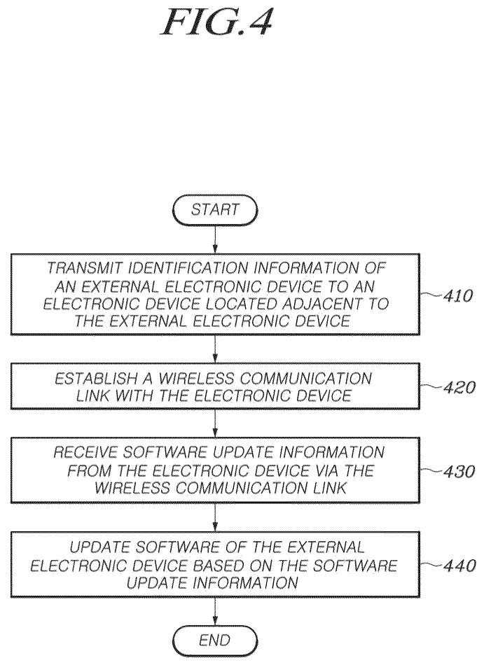

FIG. 4 illustrates an operation flow of an external electronic device according to an embodiment. The external electronic device described in FIG. 4 may include the external electronic device 130 of FIG. 1 and/or the external electronic device of FIG. 3. The electronic device described with reference to FIG. 4 may include the electronic device 110 of FIG. 1, the electronic device 200 of FIG. 2, and/or the electronic device of FIG. 3. In the description of FIG. 4, a redundant part overlapping the portion described above with reference to FIGS. 1 to 3 may be omitted. The operations of FIG. 4 are merely of an example, and some of the operations may be omitted or an operation not illustrated in FIG. 4 may be added. In the following description, for example, the external electronic device is described as a sound bar device, and the electronic device is described as a TV device, but it is merely of an example, and those operations may be applied to other devices supporting IoT technology.

According to an embodiment, in operation 410, the external electronic device may transmit identification information of the external electronic device to the electronic device located adjacent to the external electronic device.

In an embodiment, the identification information of the external electronic device may include information on a WiFi MAC address of the external electronic device.

In an embodiment, the identification information of the external electronic device may include current software version information of the external electronic device.

According to an embodiment, in operation 420, the external electronic device may establish a wireless communication link with the electronic device.

In an embodiment, the wireless communication link may be established based on WiFi direct technology.

According to an embodiment, in operation 430, the external electronic device may receive software update information from the electronic device via the established wireless communication link. The operation 430 may include an operation corresponding to the operation 370 of FIG. 3.

According to an embodiment, in operation 440, the external electronic device may update the software of the external electronic device based on the software update information.

In an embodiment, the external electronic device may store the software update information.

In an embodiment, the external electronic device may receive and store image quality data of the electronic device from the electronic device.

In an embodiment, the external electronic device may transmit the stored image quality data received from the electronic device back to the electronic device, upon request from the electronic device.

Based on the above description, when backing up TV data due to a physical failure of a TV device or for software updates of a TV peripheral device (or IoT device) having no connection with a communication network, the user may utilize a storage space of the TV device and the TV peripheral device to conveniently back up its image quality data through an automatic connection, without any need to visit a service center or the like with the TV device or the TV peripheral device. For example, in the case of an OLED TV, a large amount of image quality compensation data for its OLED panel using self-emitting light elements may be backed up in advance to restore the data to its original state without the help of a service engineer even in the event of a circuit failure or circuit replacement. For example, when a TV peripheral such as e.g., a soundbar, an IoT device, or a set-top box is not connected to the network, the TV's storage space may be used to check for software updates and receive its related data directly from the TV device.

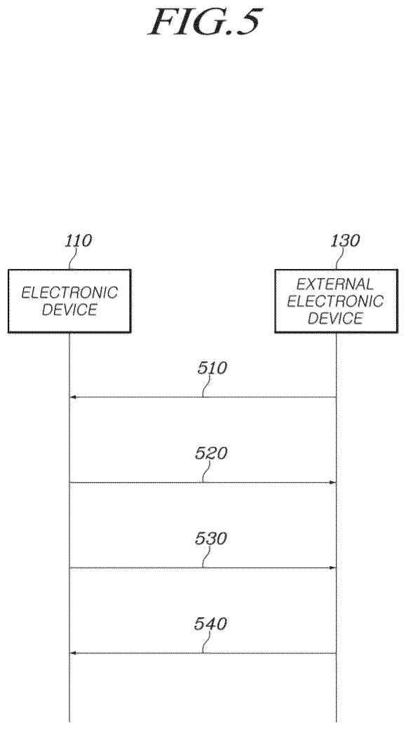

FIG. 5 illustrates a signaling flow between an electronic device and an external electronic device according to an embodiment. In description of FIG. 5, any portion that is redundant of those portions described with reference to FIGS. 1 to 4 may be omitted.

According to an embodiment, in operation 510, the external electronic device 130 may transmit identification information of the external electronic device to the electronic device 110. The operation 510 may include the operation 320 of FIG. 3 and the operation 410 of FIG. 4.

According to an embodiment, in operation 520, the electronic device 110 may transmit software update information to the external electronic device 130. The operation 520 may include the operation 370 of FIG. 3 and the operation 430 of FIG. 4. For convenience of description, although not illustrated in FIG. 5, a determination operation (e.g., determining whether to update the software) of the electronic device and the external electronic device described with reference to FIGS. 3 and 4 may be included between operation 510 and operation 520.

According to an embodiment, in operation 530, the electronic device 110 may transmit image quality data to the external electronic device 130.

In an embodiment, when it is identified that the image quality data is not backed up, the electronic device 110 may transmit the image quality data to the external electronic device.

According to an embodiment, in operation 540, the external electronic device 130 may transmit the image quality data to the electronic device 110. As such, the external electronic device 130 may not only update the software of the external electronic device 130 through the electronic device 110, but also back up the image quality data of the electronic device 110 using a storage space of the external electronic device 130, thereby enabling efficient management of data.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. For example, a component expressed in the singular is to be understood as including a plurality of components unless the context clearly indicates only a singular meaning. As used in the disclosure, the term “and/or” is to be understood to encompass all possible combinations of one or more of the enumerated items. As used in the disclosure, the terms “comprise”, “have”, “include”, “consist of”, and the like are intended only to designate the presence of features, components, parts, or combinations thereof described in the disclosure, and the use of such terms is not intended to exclude the possibility of presence or addition of one or more other features, components, parts, or combinations thereof. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st”, “2nd”, or “first” or “second” may be used to simply distinguish a corresponding component from another, and does not limit the components in other aspect (e.g., importance or order).

As used in connection with various embodiments of the disclosure, the term “˜portion” or “˜module” may include a unit implemented in hardware, software, or firmware, and may interchangeably be used with other terms, for example, “logic”, “logic block”, “part”, or “circuit”. Such a “˜portion” or “˜module” may be a single integral component, or a minimum unit or a part of the component, adapted to perform one or more functions. For example, according to an embodiment, the “˜portion” or “˜module” may be implemented in the form of an application-specific integrated circuit (ASIC).

As used in connection with various embodiments of the disclosure, the term “in case where (or that) ˜” may be interpreted to mean “when ˜”, “if ˜”, “in response to determining ˜”, or “in response to detecting ˜”, depending on the context. Similarly, the phrases “when it is determined that ˜” or “when it is detected that ˜” may be interpreted to mean “when determining ˜”, “in response to determining ˜”, “when detecting ˜” or “in response to detecting ˜”, depending on the context.

The program executed by an electronic device 110 and an external electronic device 130 as described in the disclosure may be implemented as a hardware component, a software component, and/or a combination of the hardware component and the software component. The program may be performed by any system capable of executing computer-readable instructions.

Software may include a computer program, a code, an instruction, or a combination of one or more of them, and may configure a processing unit to operate as desired or instruct the processing unit independently or collectively. The software may be implemented as a computer program including instructions stored in a computer-readable storage medium. The computer-readable storage media may include, for example, magnetic storage media (e.g., read-only memory (ROM), random-access memory (RAM), a floppy disk, hard disk, etc.), optical readable media (e.g., compact disc read only memory (CD-ROM), digital versatile disc (DVD)) and the like. The computer-readable storage media may be distributed over networked computer systems, so that computer-readable codes may be stored and executed in a distributed manner. The computer program product may be distributed (e.g., downloaded or uploaded) directly or online through an application store (e.g., PlayStore™) or between two user devices (e.g., smartphones). If distributed online, at least part of the computer program product may be at least temporarily stored or generated in a machine-readable storage medium, such as memories of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
communication circuitry;
memory storing instructions; and
at least one processor operatively connected to the communication circuitry and the memory,
wherein the instructions, when executed by the at least one processor, cause the electronic device to:
establish a first wireless communication link with an access point (AP) connected to a network;
obtain, from an external electronic device located adjacent to the electronic device, identification information of the external electronic device;
establish a second wireless communication link with the external electronic device based on the identification information of the external electronic device;
obtain software update information of the external electronic device from the network via the first wireless communication link;
store the software update information of the external electronic device in the memory;
determine to update software of the external electronic device; and
provide the software update information of the external electronic device to the external electronic device via the second wireless communication link.

2. The electronic device of claim 1, wherein the instructions, when executed by the at least one processor, cause the electronic device to:
identify that image quality data of the electronic device is not backed up; and
provide the image quality data to the external electronic device via the second wireless communication link.

3. The electronic device of claim 1, wherein the first wireless communication link is established based on WiFi technology, and the second wireless communication link is established based on WiFi Direct technology.

4. The electronic device of claim 1, wherein the identification information of the external electronic device comprises a Wi-Fi media access control (MAC) address of the external electronic device and software version information of the external electronic device.

5. The electronic device of claim 4, wherein the instructions, when executed by the at least one processor, cause the electronic device to:
based on the software version information of the external electronic device not matching the software update information of the external electronic device, determine to update the software of the external electronic device; and
based on the software version information of the external electronic device matching the software update information of the external electronic device, determine to not update the software of the external electronic device.

6. The electronic device of claim 1, wherein the identification information of the external electronic device is obtained through a wired communication link based on a high-definition multimedia interface (HDMI) or a wired communication link through an optical cable.

7. The electronic device of claim 1, wherein the instructions, when executed by the at least one processor, cause the electronic device to:
establish a third communication link with the external electronic device; and
obtain the identification information of the external electronic device from the external electronic device based on the third communication link, and
wherein the third communication link is established based on Bluetooth communication technology.

8. The electronic device of claim 1, wherein the identification information of the external electronic device is obtained through the AP, and
wherein the external electronic device is connected to the AP.

9. The electronic device of claim 1, wherein the instructions, when executed by the at least one processor, cause the electronic device to:
compress the software update information, and
provide the compressed software update information to the external electronic device via the second wireless communication link.

10. The electronic device of claim 2, wherein the instructions, when executed by the at least one processor, cause the electronic device to, based on identifying that a device unique identifier (DUID) of the electronic device is changed, obtain the image quality data from the external electronic device.

11. An external electronic device comprising:
communication circuitry;
memory storing instructions; and
at least one processor operatively connected to the communication circuitry and the memory,
wherein the instructions, when executed by the at least one processor, cause the external electronic device to:
provide identification information of the external electronic device to an electronic device located adjacent to the external electronic device;
establish a wireless communication link with the electronic device;
obtain software update information from the electronic device via the wireless communication link; and
update software of the external electronic device, based on the software update information.

12. The external electronic device of claim 11, wherein the instructions, when executed by the at least one processor, cause the external electronic device to obtain image quality data of the electronic device from the electronic device via the wireless communication link, and store the image quality data of the electronic device in the memory.

13. The external electronic device of claim 11, wherein the identification information of the external electronic device comprises information on a Wi-Fi media access control (MAC) address of the external electronic device and software version information of the external electronic device.

14. The external electronic device of claim 11, wherein the wireless communication link is established based on WiFi Direct technology.

15. The external electronic device of claim 11, wherein the identification information of the external electronic device is provided through a wired communication link based on a high-definition multimedia interface (HDMI) or a wired communication link through an optical cable.

16. A method of an electronic device, the method comprising:
establishing a first wireless communication link with an access point (AP) connected to a network;
obtaining, from an external electronic device located adjacent to the electronic device, identification information of the external electronic device;
establishing a second wireless communication link with the external electronic device based on the identification information of the external electronic device;
obtaining software update information of the external electronic device from the network via the first wireless communication link;
storing the software update information of the external electronic device in the memory;
determining to update software of the external electronic device; and
providing the software update information of the external electronic device to the external electronic device via the second wireless communication link.

17. The method of claim 16, further comprising:
identifying that image quality data of the electronic device is not backed up; and
providing the image quality data to the external electronic device via the second wireless communication link.

18. The method of claim 17, further comprising:
based on identifying that a device unique identifier (DUID) of the electronic device is changed, obtaining the image quality data from the external electronic device.

19. The method of claim 16,
wherein the identification information of the external electronic device comprises a Wi-Fi media access control (MAC) address of the external electronic device and software version information of the external electronic device.

20. The method of claim 19, further comprising:
based on the software version information of the external electronic device not matching the software update information of the external electronic device, determining to update the software of the external electronic device; and
based on the software version information of the external electronic device matching the software update information of the external electronic device, determining to not update the software of the external electronic device.
